(19) United States
(12) Patent Application Publication
(10) Pub. No.: US 2024/0403166 A1
(43) Pub. Date: Dec. 5, 2024

(54) METHOD, APPARATUS AND A NON-TRANSITORY MACHINE-READABLE STORAGE MEDIUM INCLUDING FIRMWARE FOR A CXL MEMORY DEVICE

(71) Applicant: Intel Corporation, Santa Clara, CA (US)

(72) Inventors: Zhonghua SUN, Shanghai (CN); Pei GAO, Shanghai (CN); Yue LIU, Shanghai (CN); Liangqi ZHU, Shanghai (CN); Yue YAO, Shanghai (CN); Junyu TONG, Shanghai (CN); Hua MA, Shanghai (CN); Cong ZHANG, Shanghai (CN)

(21) Appl. No.: 18/735,239

(22) Filed: Jun. 6, 2024

(30) Foreign Application Priority Data
Nov. 22, 2023 (WO) PCT/CN2023/133234

(51) Int. Cl. G06F 11/10; G06F 11/07

(52) U.S. Cl. CPC G06F 11/1068; G06F 11/0778; G06F 11/1016

(57) ABSTRACT

Provided is a method comprising obtaining information about a detected memory error in a memory device, the memory device being connected to a first host via a compute express link, CXL, interface. The method comprises further recording the memory error information into a firmware of the memory device.

### BACKGROUND

Compute Express Link (CXL) is supported by many different processors. CXL devices may have an increasing number of applications, such as in a shared host-managed device memory (HDM) or in a memory device. Therefore, error signaling and logging of errors may be important requirements for smooth operations at the CXL link-level, host-level, device-level, and system-level to ensure that any errors that occur within a system are diagnosed and resolved in a time-efficient and cost-saving manner (such as RAS protocol, i.e., reliability, availability, and serviceability).

### BRIEF DESCRIPTION OF THE FIGURES

Some examples of apparatuses and/or methods will be described in the following by way of example only, and with reference to the accompanying figures, in which

FIG. 1 illustrates a flowchart of an example of a method;

FIG. 2 illustrates a block diagram of an example of an apparatus;

FIG. 3 illustrates a block diagram of an example of an apparatus;

FIG. 4 illustrates a block diagram of an example of a system;

FIG. 5 illustrates an example of a system 500 of two hosts with a corrupted CXL device according to a previous approach;

FIG. 6 illustrates an example of a system 600 of two hosts with a corrupted CXL device according to the current disclosure;

FIG. 7 illustrates an example of a flowchart of an error recording flow chart 700 as described in this disclosure; and

FIG. 8 illustrates an example of a flowchart of an error masking flow chart 800 as described in this disclosure.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

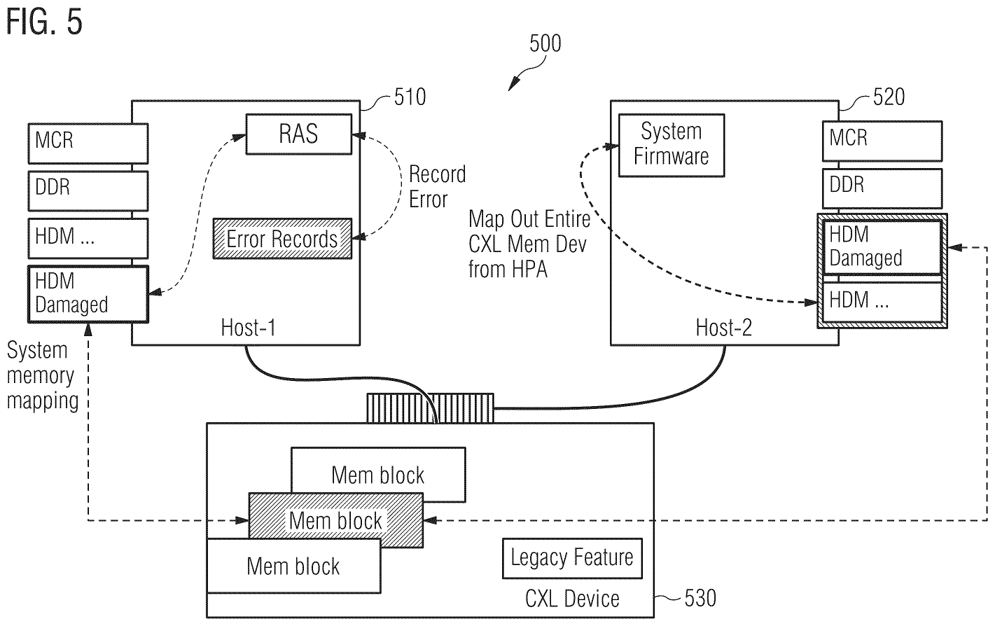

In previous approaches (as for example shown in FIG. 5 below), a CXL device that supports a memory error logging and signaling enhancements capability may log such errors locally at the host (for example the firmware of the host) and expose the error log to system software via the memory-mapped I/O (MMIO) Mailbox so that all logged errors are made available to the host to support platform-level RAS features. The previous approach may therefore rely on the server RAS feature to passively detect device errors during use. CXL 2.0/3.0 may introduce a new feature to map out permanent memory faults at boot time in host-managed device memory (HDM). A device may accomplish that by shrinking the size of HDM window to map out the faulty location via internal hardware mechanisms. Therefore, error records stored on the CXL device will be lost if the device is completely powered down. When connecting this CXL device to another host, system firmware may encounter uncorrected errors during scanning and disable the whole CXL device to make sure the system boots. Further, even if error records stored on the CXL device may be sticky across device resets (when devices that consume auxiliary power must preserve the error records when auxiliary power consumption is enabled) the error records may still be lost if the device is completely powered down or switched, i.e., it cannot be leveraged by another host.

The present disclosure addresses the problem of data loss when the CXL device is fully powered off or switched hosts. The described technique utilizes a Coherent Device Attribute Table (CDAT) interface to record errors into the CXL device firmware and communicate this information to the host software. Since CDAT is stored in CXL firmware, it will remain intact even when the device has been fully powered off or switches hosts. When a CXL device with defective memory units is connected to another host, invalid memory unit information can be obtained from the new CDAT table. This allows the host (for example the host firmware) to only map out the damaged memory regions, thereby preventing the entire CXL device from being disabled.

The current disclosure proposes a technique referred to as CXL Memory Block Error Synchronization (CMBES) among different hosts. When a CXL device is moved from a first host to a second host, or switched over via CXL switch, the second host gets the Error info via CMBES. The current disclosure implements a mechanism of recording and masking invalid CXL memory device units, which may therefore not need to redetect the error and RAS handle flow and may reuse the CXL device because the invalid memory unit is masked and recorded. That is if the memory of a CXL device becomes damaged and is recorded into the CXL device firmware by the first host, when the device is connected to the second host, this second host can detect the error and map out the damaged memory during boot.

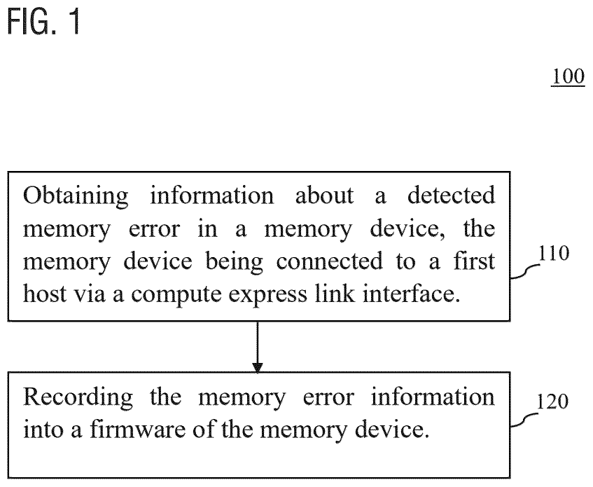

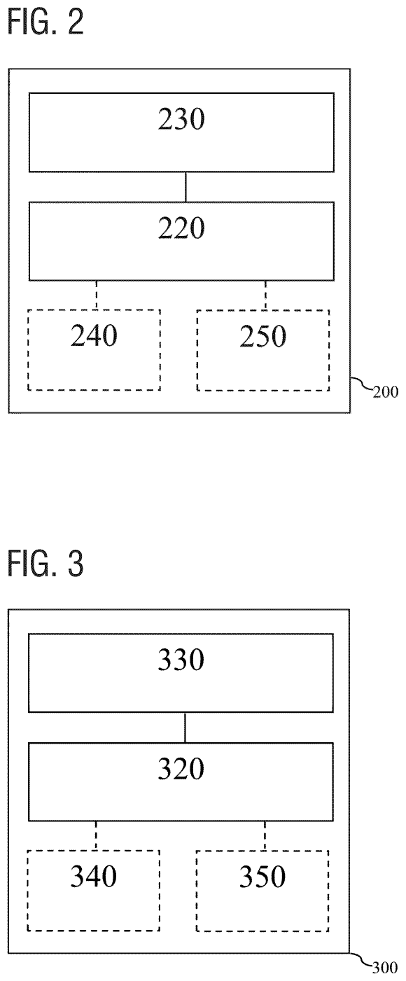

FIG. 1 illustrates a flowchart of an example of a method 100. The method 100 may, for instance, be performed by an apparatus as described herein, such as apparatus 200 or 300 (see FIGS. 2 and 3). The method 100 comprises obtaining 110a detected memory error in a memory device. The memory device may be connected to a first host via a compute express Link™ (CXL™) interface.

The first host (also referred to as host or host system or host computer system) may be a computer system (for example apparatus 200) or server or the like that may manage and interact with connected devices, such as the memory device. For example, the first host may comprise a processing circuitry such as a central processing unit (CPU), a motherboard, a memory device, storage circuitry, interface circuitry, and/or peripheral components. The comprises or is connected to the memory device via the CXL interface.

The Compute Express Link (CXL) interface is a high-speed interconnect standard (e.g., a set of protocols and specifications) that optimizes the interaction between a processing circuitry of the host (such as the CPU of) and peripheral devices and/or memory devices. CXL is built on the PCI Express (PCIe) infrastructure bus. CXL may incorporate several protocols to enhance system performance. For example, a CXL.io protocol may extend PCIe functions to manage device configuration and simple data transfers. Further, CXL.cache protocol may enable peripherals to access and cache the processing circuitry's (e.g., CPU's) memory, allowing for low-latency interactions directly with host memory. Further, CXL.mem protocol may allow the processing circuitry (e.g., CPU) to access a memory device seamlessly, both volatile and non-volatile, which integrates external memory devices directly into the host system's memory hierarchy. CXL may also be defined in the “Compute Express Link™ (CXL™) Specification”, from August 2023, Revision 3.1 or in older or newer versions of this specification.

For example, the memory device which is connected to the first host via CXL is a device (for example a hardware component) that extends and/or enhances the memory capabilities of the host system. This may be done, for example, by leveraging the high-speed, low-latency CXL interface. The memory device may be designed to integrate seamlessly into the system's memory hierarchy, benefiting from CXL's protocols for coherent data access and memory expansion. For example, the memory device may provide additional memory resources that are directly accessible by the CPU, improving system performance and memory capacity without the bottlenecks of traditional memory interfaces. For example, the memory device may be a memory expander. A memory expander may be a device that increase the available memory beyond what is installed directly on motherboard of the host. A memory expander may be used in host systems where large datasets are processed, allowing for rapid access to a significantly expanded memory pool. In another example, the memory device may be a memory accelerator. The memory accelerator may be a device designed to enhance the memory subsystem of the host system, for example by utilizing CXL. The memory accelerator may be connected to the processing circuitry (e.g., the CPU) via the CXL interface. The memory accelerator may improve data processing speeds by offering additional memory resources or by optimizing memory operations such as caching, prefetching, and data management. The memory accelerator may support the processing circuitry of the host system (e.g., the CPU) by handling memory-intensive tasks more efficiently, reducing latency and increasing throughput for applications that demand high-speed access and manipulation of large volumes of data. In yet another example, the memory device may be a persistent memory device, which may combine attributes of volatile memory (such as RAM) and storage. A persistent memory device may offer the speed of a volatile memory with the persistence of storage and may retain data even when power is off. For example, the memory device may be a CXL-enabled storage device (such as a solid state drive) which may be integrated into the host system's memory architecture via CXL interface, allowing the processing circuitry (such as the CPU) to access storage device at speeds closer to that of main memory (such as RAM).

A memory error of the memory device may refer to instances where data stored in memory device is corrupted, inaccurately read or written, or lost, due to a hardware malfunction, software faults, or external disruptions or the like. For example, the memory error in the memory device may occur within a specific segment or block of memory device, where data may become corrupted, unreadable, or incorrectly written (this may be referred to as memory block error or Memblock error). In this case, the memory error may be confined to discrete areas or blocks of memory, making them location-specific and for example affecting only parts of the memory device without compromising the entire memory device. For example, the memory error may be a hard error which may result from physical damage to the memory hardware or parts of the memory hardware, such as a failed memory cell. A hardware error may be persistent and may lead to repeated incorrect data outputs from the affected areas. For example, the memory error may be a row hammer error, which may happen when repeated access to a memory row inadvertently affects adjacent rows, flipping their bits (for example in RAM). In yet another example, the memory error may be bit error, which may occur when individual bits of data in memory incorrectly change state, often due to electrical noise or interference, and can lead to widespread data corruption if not addressed. For example, soft memory errors, may be caused by transient phenomena like cosmic rays, do not damage the hardware but alter the data stored in memory cells, making them challenging as they are random and non-reproducible.

For example, the memory error may be detected by the host system, that is for example by an operating system of the first host system or by a firmware (for example an UEFI BIOS) of the first host. For example, the memory error detection is carried out through dedicated monitoring routines and diagnostic modules integrated into its host system firmware. These features may actively monitor memory transactions and utilize error detection technologies, such as ECC (Error-Correcting Code) and/or parity checks, to identify discrepancies or failures. In some examples, the detection of the memory error is carried out by a memory reliability management module. The memory reliability management module may be part of a firmware of the first host, or it may be part of the operating system of the first host. For example, the memory reliability management module may be reliability, availability, and serviceability (RAS) feature and/or the firmware of the first host is a BIOS (for example a UEFO BIOS).

For example, the memory error may be detected by an external apparatus connected to the memory device. In yet another example, the memory error may be detected by the memory device itself. For example, the memory device itself may use a built-in error detection mechanism such as Error-Correcting Code (ECC) or parity checks or the like to detect an error. For example, these systems continuously monitor data as it is written to and read from the memory device, comparing it against expected values or using additional bits to verify the integrity of the data. When discrepancies or unexpected patterns are identified, indicating a potential memory error, the memory error may be logged. For example, the memory device, may transmit the detected memory error which may be obtained by the to the host system or the external device.

The method 100 comprises further recording 120 the memory error information into a firmware of the memory device. The memory device comprises a firmware. The firmware of the memory device is a software that is permanently embedded into the hardware of the memory device to control and manage specific functions. The firmware of the memory device may be stored in a non-volatile memory, and thereby remain intact and operational even when the memory device is powered off. The firmware of the memory device may store software that is configured for tasks such as managing data storage algorithms, error checking and correction, and interfacing with the operating system or host CPU. For example, a RAS feature of the system of the first host may trigger the recording of the memory error information into the firmware of the memory device.

For example, the firmware of the memory device may comprise a device attribute table (DAT). A DAT may be a data structure, for example a structured repository, for storing and managing configuration settings and operational attributes of the memory device. For example, the stored operational attributes may be a memory device ID, a performance metric, configuration parameters, and status indicators or the like. In some examples, the firmware of the memory device may be a coherent device attribute table (CDAT). A CDAT may be a data structure used for a CXL device, for example a structured repository, for storing and managing configuration settings and operational attributes of the CXL memory device. The CDAT may provide configuration settings and operational attributes for maintaining system-wide coherence and performance, such as information on latency, bandwidth, memory configurations, and other critical performance characteristics of the CXL memory device (see also table 3 below). The CDAT may also be defined as described in defined in the “Compute Express Link™ (CXL™) Specification”, from August 2023, Revision 3.1 or in older or newer versions of this specification.

In some examples, the memory error information may be recorded into the device attribute table (DAT) of the firmware of the memory device. In yet another example, the memory error information may be recorded into the coherent device attribute table (CDAT) of the firmware of the memory device.

In some examples, the recording of the memory error information into the firmware of the memory device may be carried out by the memory reliability management module of the first host. For example, the memory reliability management module is part of the firmware of the first host or of the operating system of the first host. In some examples, the memory reliability management module is a RAS feature, and/or the firmware of the first host is BIOS (for example a UEFI BIOS).

In some examples, the method 100 further comprises masking the detected memory error in the memory device. Masking may comprise configuring the first host system to bypass the corrupted memory block during operations. Masking may be performed independently from which host has detected and recorded the memory error. This is done by reading from the memory device firmware (for example form the CDAT) which specific areas of memory are corrupted and should be avoided by the host system when reading or writing data.

The above described technique may result in a detected and recorded memory error of the memory device being stored permanently, also in cases that the memory device is powered off. Therefore, even after powering off the memory device the memory error is still available host after powering-on again without performing error detection again. The host does not need to redetect the memory error and does not need to perform a memory reliability method. Therefore, the CXL memory may be reusable because the corrupted memory (block) is recorded and masked.

In some examples, the method further comprises switching the memory device from being connected to the first host to being connected to a second host via the CXL interface. The method 100 may further comprise obtaining by the second host the recorded memory error information about the detected memory error from the firmware of the memory device.

The above described technique may result in a detected and recorded memory error of the memory device being stored permanently, also in cases that the memory device is switch from the first host to the second host. Therefore, even after host-switching the memory device the memory error is available to the second host without the second host performing error detection again. The second host does not need to redetect the memory error and does not need to perform a memory reliability method. That is the second host can immediately mask the memory error and thereby it is prevented that the second host repeatedly encounters the same error, which would otherwise require re-detection and could disrupt ongoing operations. Therefore, the CXL memory device can continue to utilize the remaining healthy parts of the CXL memory device effectively, enhancing reliability and efficiency without the need for frequent error re-checks. Therefore, the CXL memory device may be reusable because the corrupted memory (block) is recorded and masked.

In some examples, the method 100 further comprises communicating between the first host and the memory device based on a data object exchange (DOE) interface. The DOE is a mechanism (defined by Peripheral Component Interconnect Special Interest Group (PCI-SIG), which is an industry consortium responsible for the development and management of the PCI standards) for structured data exchanges between the host system and the PCIe device, such as the CXL connected memory device. In CXL, the DOE allows for the efficient transmission of complex data objects, which include configurations, operational commands, and status updates. For instance, a specified Vendor ID of 1E98h is used to ensure compatibility and correct processing across different devices. This standardized communication protocol enhances system interactions by facilitating precise and coherent data handling, crucial for maintaining high performance and reliability in advanced computing systems. For example, this is also described in the “Compute Express Link™ (CXL™) Specification”, from August 2023, Revision 3.1 or in older or newer versions of this specification.

In some examples, the method comprises communicating the error memory error information between the first host and the memory device based on a first data structure. For example, a data structure that is an accepted industry standard data structure in field may be used for improved compatibility. In some examples, the first data structure comprises a write entry request field. For example, the already established data structure in the field may be extended by an entry request filed. For example, the entry request may be used to inform the firmware (for example the CDAT) that an information on the memory error is being recorded. In some examples, the first data structure is a CXL DOE access table. The CXL DOE access table may be extended by an entry request field (see also table below) to communicate with the CDAT that new information on the memory error is being recorded. For example, this is also described in the above cited CXL Specification.

In some examples, the CXL DOE access table may be organized as shown in table 1 below. The CXL DOE access table may be extended write entry request in the last row “These Bytes only use for writing entry request. The table entry that corresponds to the EntryHandle field.”:

TABLE 1
DOE Access Table of Write Entry Request

| Data Object | Length | |
|---|---|---|
| Byte Location | in Bytes | Description |
| 00h | 8 | Standard DOE Request Header-See |
| | | PCIe Base Specification. |
| 08h | 1 | Table Access Request Code- |
| | | 1 to indicate this is a request |
| | | to write an entry. |
| | | All other values are reserved. |
| 09h | 1 | Table Type- |
| | | 0-CDAT |
| | | All other types are reserved. |
| 0Ah | 2 | EntryHandle-Handle value associated |
| | | with the entry being requested. |
| | | For Table Type = 0, EntryHandle = |
| | | 0 specifies that the request |
| | | is for the CDAT header and |
| | | EntryHandle > 0 indicates |
| | | the request is for the |
| | | CDAT Structure[EntryHandle-1] |
| 0Ch | Variable | These Bytes only use for |
| | | writing entry request. |
| | | The table entry that corresponds |
| | | to the EntryHandle field. |

In some examples, the method 100 further comprises receiving a write entry response after recording the memory error information about the detected memory error into the firmware of the memory device. For instance, the memory device may issue a response to the host after writing to the CDAT. In some examples, the response may be organized as the write DOE access table entry response shown in table 2 below:

TABLE 2
DOE Access Table of Write Entry Response

| Data Object | Length | |
|---|---|---|
| Byte Location | in Bytes | Description |
| 00h | 8 | Standard DOE Request Header-See PCIe |
| | | Base Specification. |
| 08h | 1 | Table Access Request Code- |
| | | 1 to indicate this is a request |
| | | to write an entry. |
| | | All other values are reserved. |
| 09h | 1 | Table Type- |
| | | 0-CDAT |
| | | All other types are reserved. |
| | | Shall match the input supplied during the |
| | | matching Write Entry Request. |
| 0Ah | 2 | EntryHandle-EntryHandle value associated |
| | | with the next entry in the Table. |
| | | EntryHandle = FFFFh represents the very |
| | | last entry in the table and thus end of |
| | | the table. |

In some examples, the firmware comprises a second data structure. The second data structure comprising data specifying the detected memory error of the memory device. For example, the already existing firmware is extended by including an additional data structure for recording the specific detected memory error of the memory device. For example, the second data structure is included into the CDAT of the firmware of the memory device. That is the already existing CDAT may be extended by including the additional second data structure for recording the specific detected memory error of the memory device. Thereby, the information on the error of the memory device can be recorded without including new hardware or complex software but by re-using and extending already existing firmware data structures like the CDAT.

In some examples, the second data structure is a device scoped memory defect structure (DSMDS). The DSMDS data structure may be organized as shown in the table 3 below:

TABLE 3
Device Scoped Memory Defect Structure (DSMDS)

| | Byte | Byte | |
|---|---|---|---|
| Field | Length | Offset | Description |
| Type | 1 | 0 | 6, Device Scoped Memory Defect |
| | | | Structure (DSMDS) |
| Reserved | 1 | 1 | Reserved |
| Length | 2 | 2 | Length of this record. Varies |
| | | | (8 + Entries * size of DSMDE) |
| Handle | 1 | 4 | The handle used to refer to this |
| | | | DSMDS. Each instance |
| | | | of DSMDS shall be associated |
| | | | with a unique DSMDS |
| | | | Handle value. |
| Entries | 1 | 5 | Number of Device Scoped |
| | | | Memory Defect Entry. |
| Reserved | 2 | 6 | Reserved |
| DSMDE | | | Variable number of DSMDE |
| | | | entries describing the |
| | | | memory defect ranges. The |
| | | | format of each entry is |
| | | | defined in DSMDE. These |
| | | | entries should describe all |
| Entry[ ] | 16 * n | 8 | invalid memory range within the device. |

In some examples, the second data structure specifies at least one of a physical memory address of the memory device associated with the memory error, a range of a physical memory address of the memory device associated with the memory error, a device physical address base or a device physical address size. The physical memory address may specify the exact location within the memory device where the error occurred, pinpointing a single memory cell or a small block of memory. The range of the physical memory address may expand on the single address by defining a range, which covers a larger block of memory that includes the beginning and ending addresses. This is useful for errors that affect more than a single point, spanning a continuous segment of memory. The device physical address base may refer to the starting physical address of a memory region or block within the device that is relevant to the error. It sets a baseline from which other measurements or locations can be calculated. The device physical address size may refer to the size of the memory area, starting from the physical address base, that is affected by the error. It helps in understanding the extent of the memory area that needs to be examined or isolated due to the error. For example, this information may be stored in a data field in the second data structure. For example, this information may be stored in a device scoped memory defect entry (DSMDE) in the DSMDS data structure, as shown in table 4 below. The second host may use this DSMDE structure to return the device physical address (DPA) range and the like.

TABLE 4
Device Scoped Memory Defect Entry (DSMDE)

| | Byte | Byte | |
|---|---|---|---|
| Field | Length | Offset | Description |
| DPA Offset | 8 | 0 | Offset of the memory defect range |
| | | | from CXL HDM base address. |
| DPA Length | 8 | 8 | Length of this range in bytes. |

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-8).

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240. For example, the apparatus 200 comprises a CXL memory device 250.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2a comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information. The interface circuitry 220 may comprise one or more interfaces. For example, the interface circuitry 220 may comprise a CXL interface. For example, the CXL interface may connect the memory device 250 to the processing circuitry 230 or to other components of the apparats 200.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured to obtain information about a detected memory error in a memory device. The memory device is connected to a first host via a compute express link, CXL, interface. The processing circuitry 230 is further configured to record the memory error information into a firmware of the memory device. For example, apparatus 200, comprising the processing circuitry 230, may be the first host or part of the first host. The apparatus 200 may further comprise the CXL device 250 which is connected to the processing circuitry 230 via the CXL interface 220. In another example, apparatus 200 may be connected to the first host and/or the CXL memory device, for example, via the interface circuitry 220.

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-8).

FIG. 3 illustrates a block diagram of an example of an apparatus 300 or device 300. The apparatus 300 comprises circuitry that is configured to provide the functionality of the apparatus 300. For example, the apparatus 300 of FIG. 3 comprises interface circuitry 320, processing circuitry 330 and (optional) storage circuitry 340. For example, the processing circuitry 330 may be coupled with the interface circuitry 320 and optionally with the storage circuitry 340. For example, the apparatus 300 comprises a CXL memory device 350.

The apparatus 300 and its components may be similar to apparatus 200 and its components.

The processing circuitry 330 is configured to obtain a recorded memory error information about a detected memory error from a firmware of a memory device connected to a second host. The memory error was detected while the memory device was connected to a first host, and wherein the corresponding memory error information was recorded into the firmware of the memory device while the memory device was connected to the first host. For example, apparatus 300, comprising the processing circuitry 330, may be the second host or part of the second host. The apparatus 300 may further comprise the CXL device 350 which is connected to the processing circuitry 330 via the CXL interface 320. In another example, apparatus 300 may be connected to the second host and/or the CXL memory device, for example, via the interface circuitry 320.

For example, the CXL device 350 is the same as the CXL device 250, wherein the this CXL device is switched from the first host (for example the apparatus 200) to the second host (for example the apparatus 300).

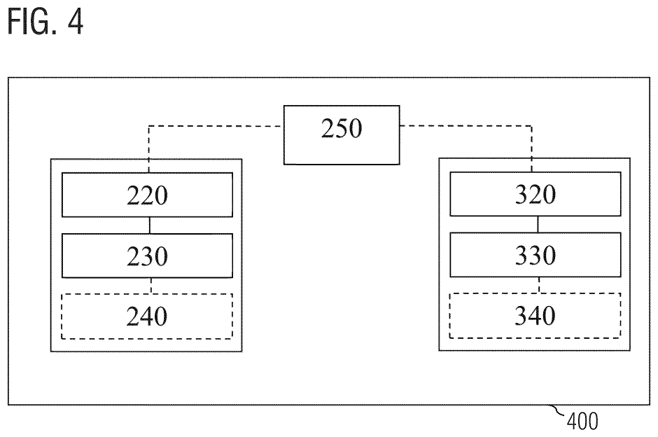

Further details and aspects are mentioned in connection with the examples described above or below. The example shown in FIG. 3 may include one or more optional additional features corresponding to one or more aspects mentioned in connection with the proposed concept or one or more examples described above (e.g., FIG. 1 to 2) or below (e.g., FIGS. 4-8).

FIG. 4 illustrates a block diagram of an example of a system 400. The system 400 comprises the apparatus 200 and the apparatus 300 as described above. The CXL device 250/350 may be switched from apparatus 200 (first host) to apparatus 300 (the second host) or vice versa.

The processing circuitry 230 may be configured to obtain information about a detected memory error in a memory device, the memory device being connected to the first host (e.g., apparatus 200) via a compute express link, CXL, interface. The processing circuitry 230 may be further configured to record the memory error information into a firmware of the memory device. The CXL device may be switched from the first host (e.g., apparatus 200) to the second host (e.g., apparatus 300)

The processing circuitry 320 may be configured to obtain the recorded memory error information about a detected memory error from the firmware of the memory device connected to the second host (e.g., apparatus 300). The memory error was detected while the memory device was connected to the first host (e.g., apparatus 200). The corresponding memory error information was recorded into the firmware of the memory device while the memory device was connected to the first host (e.g., apparatus 200).

Further details and aspects are mentioned in connection with the examples described above or below. The example shown in FIG. 4 may include one or more optional additional features corresponding to one or more aspects mentioned in connection with the proposed concept or one or more examples described above (e.g., FIG. 1 to 4) or below (e.g., FIGS. 5-8).

The CXL memory device 250/350 may comprise a non-transitory machine-readable storage medium including firmware for the CXL memory device. When executed causing an apparatus to obtain a recorded memory error information about a detected memory error from the CXL memory device connected to a second host. The memory error was detected while the memory device was connected to a first host. The corresponding memory error information was recorded into the firmware of the CXL memory device while the memory device was connected to the first host.

### Examples

FIG. 5 illustrates an example of a system 500 of two hosts with a corrupted CXL device according to a previous approach. A CXL memory device 530 is connected via CXL interface to a first host 510. The firsts host 510 may comprise different memory components, such as a memory controller register (MCR), a double data rate (DDR) memory and a host-managed device memory (HDM) which may be the CXL memory device 530. The first host may detect an error in the CXL memory device 530. For example, one or more of the memory bocks (Mem block) of the CXL memory device 530 may be damaged (referred to as HDM damaged). This may be communicated (for instance via the MMIO Mailbox) to the RAS module of the first host which may be record it. Then the CXL device 530 may be disconnected from the first host 510 and be switched to the second host 520. The second host does not have any information about the damaged memory blocks of the CXL device 530 and therefore no masking of the memory error can be performed by the second host 520. Instead, the second host may either not be able to use the damaged CXL device 530 or may encounter the memory error during operation and may have to perform error detection again.

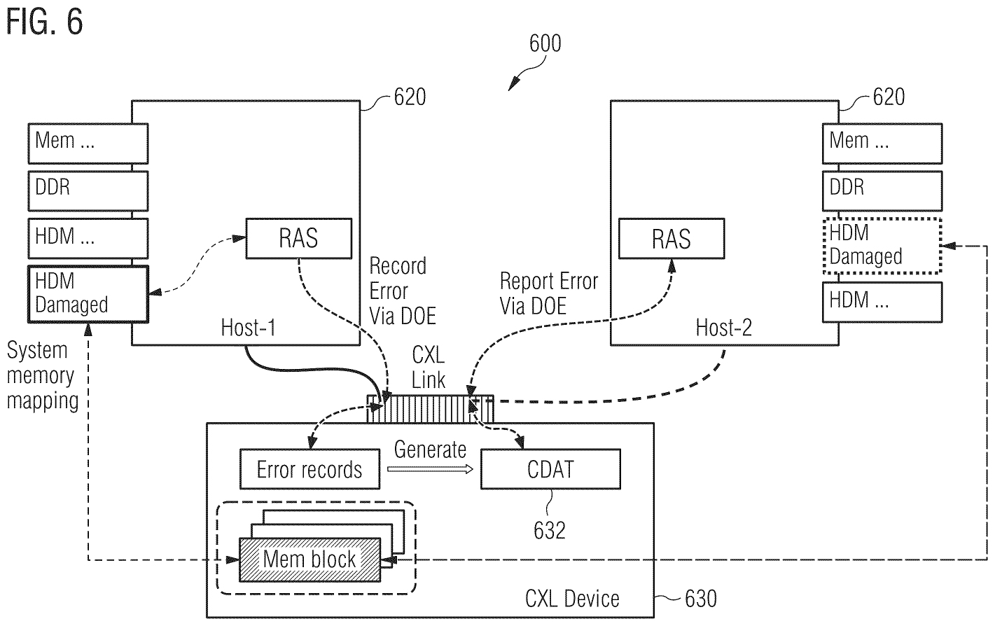

FIG. 6 illustrates an example of a system 600 of two hosts with a corrupted CXL device according to the current disclosure. A CXL memory device 630 is connected via CXL interface to a first host 610. The firsts host 610 may comprise different memory components, such as a memory controller register (MCR), a double data rate (DDR) memory and a host-managed device memory (HDM) which may be the CXL memory device 630. The first host may detect an error in the CXL memory device 630. For example, one or more of the memory bocks (Mem block) of the CXL memory device 630 may be damaged (referred to as HDM damaged). The first host 610 may communicate via a DOE interface with the CXL device 630 and record information about the detected memory error into the firmware 632 of the CXL memory device 630. The firmware may be a CDAL. Then the CXL device 630 may be disconnected from the first host 510 and be switched to the second host 620. The second host communicates with the CXL device 630 via DOE interface and may obtain the information about the damaged memory blocks of the CXL device 630 and therefore masking of the memory error can be performed by the second host 620. The second host may therefore be able to use the damaged CXL device 630 or may not have to perform error detection again. The masking of the invalid CXL memory device units may therefore not be redetected by the second host 620 because the invalid memory unit is masked and recorded. The same applies if the CXL device 630 is completely power-off and then powered-on again.

This may also be referred to as CXL Memory Block Error Synchronization (CMBES) among different hosts. When a CXL device is moved from a first host to a second host, or switched over via CXL switch, the second host gets the Error info via CMBES. That is if the memory of a CXL device becomes damaged and is recorded into the CXL device firmware by the first host, when the device is connected to the second host, this second host can detect the error and map out the damaged memory during boot.

The communication between the host and the CXL device may be performed via an extended CXL DOE mailbox (see table 1 above) to receive the error information written by the BIOS RAS code and may be stored into CDAT. Therefore, the CXL DOE access table may be extended by write entry as described in table 1 above. A response by the CXL device may be a DOE access table of write entry response as described in table 2 above.

The CDAT may be extended by a data structure in order to record information about the memory error, for example DSMDS and DSMDE data structure as described in table 3 and table 4 above.

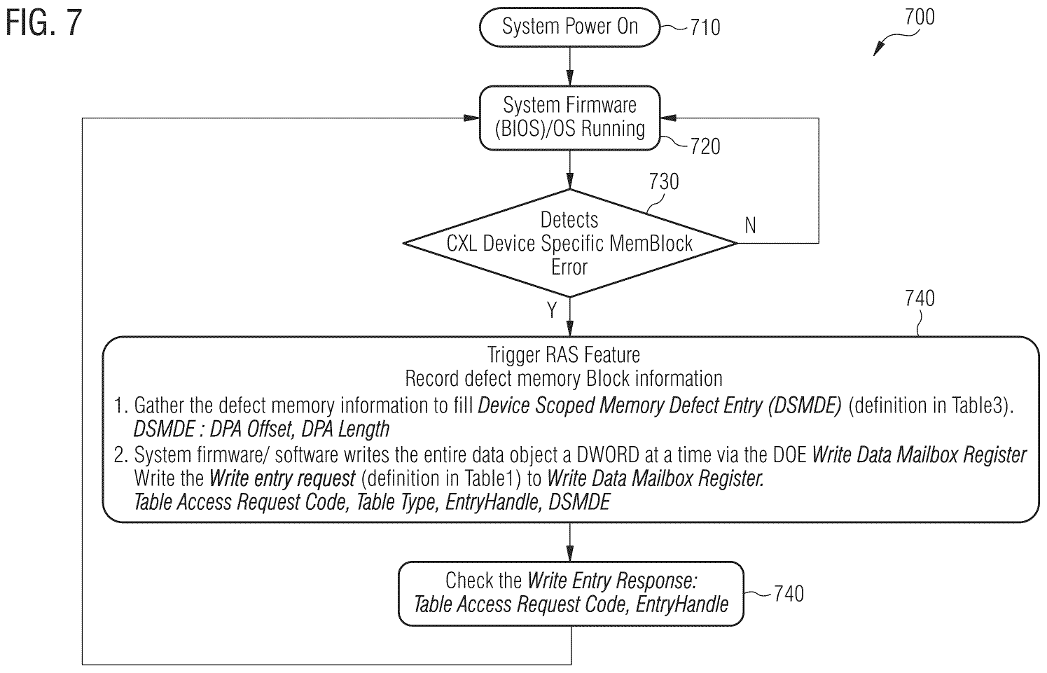

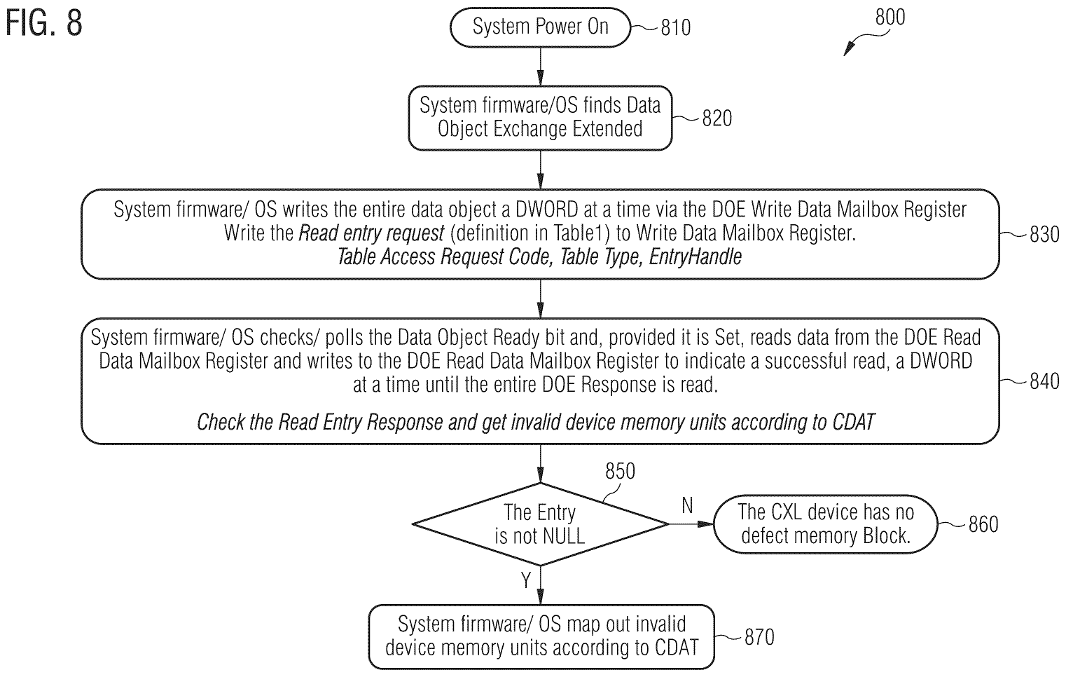

Further details and aspects are mentioned in connection with the examples described above or below. The example shown in FIG. 6 may include one or more optional additional features corresponding to one or more aspects mentioned in connection with the proposed concept or one or more examples described above (e.g., FIG. 1 to 5) or below (e.g., FIGS. 7-8).

FIG. 7 illustrates an example of a flowchart of an error recording flow chart 700 as described in this disclosure. For example, the flowchart may be carried out by the apparatus 200 (the first host). The system firmware (BIOS) detects the specific memory error and will trigger a RAS feature to record this defect memory region into CDAT via DOE. In step 710 the system (for example the first host, apparatus 200) is powered on. In step 720 the system firmware (for example UEFI BIOS)/operating system is running and operational. In step 730 it is asked if the system firmware/OS detects a CXL device specific MemBlock error. If the answer is no, the process returns to step 720. If the answer in step 730 is yes, then the process continuous with step 740. In step 740 a RAS feature is triggered to record the defect memory block information in the firmware of the memory device. Still further, in step 740 the defect memory information is gathered to fill the DSMDS structure as described above (table 3 and table 4). Still further, in step 740 host system firmware/OS finds DOE extended capability (CapID 002Eh). Still further, in step 740 the system firmware/OS checks that the DOE busy bit is clear (see also CXL specification as cited above). Still further, in step 740 the system firmware/OS writes the entire data object into a DWORD at a time via the DOE write data mailbox register and writes into the new definition write entry request as described above. The standard DOE request header may comprise the following (see also table 1 above): Table Access Request=0x01; Table Type=0x00; EntryHandle=0x06; Write: DSMDE. Still further, in step 740 the system firmware/OS writes 1 bit to the DOE go bit. Still further, in step 740 the DOE instance consumes the DOE request from the DOE mailbox. Still further, in step 740 the DOE instance generates a DOE response and sets the data object ready bit and generates a DOE software notification. In step 740 the write entry response is checked. That comprises checking the table access request code, entryhandle. See also the CXL specification as cited above for definitions of the data structures.

Further details and aspects are mentioned in connection with the examples described above or below. The example shown in FIG. 7 may include one or more optional additional features corresponding to one or more aspects mentioned in connection with the proposed concept or one or more examples described above (e.g., FIG. 1 to 6) or below (e.g., FIG. 8).

FIG. 8 illustrates an example of a flowchart of an error masking flow chart 800 as described in this disclosure. For example, the flowchart may be carried out by the apparatus 300 (the second host). The system firmware (BIOS) maps out invalid device memory units according to CDAT. In step 810 the system (for example the second host, apparatus 300) may be powered on. The system firmware (BIOS) will map out invalid device memory units according to CDAT. In step 820, the system firmware/OS finds DOE extended capability (CapID 002Eh). In step 830 the system firmware/OS checks if the DOE busy bit is clear. Further, in step 830m the system firmware/OS writes the entire data object a DWORD at a time via the DOE Write data mailbox register. Further, in step 830, the system/OS reads the recorded error information from the CXL device CDAT, that is the system/OS writes the new definition read entry request. A standard DOE request header may be as follows: Table Access Request=0x00; Table Type=0x00; EntryHandle=0x06. In step 840 the System firmware/OS writes 1 bit to the DOE go bit. Further, in step 840 the DOE instance consumes the DOE request from the DOE mailbox. Further, in step 840 the DOE instance generates a DOE response and sets the data object ready bit and generates a DOE software notification. In step 850 it is asked if the read entry response according to the CDAT (table access request code, EntryHandle and DSMDS) is null. If the answer in step 850 is no, then it is proceeded with step 860. In step 860, it is determined that the CXL device has not defect memory block. If the answer in step 860 is yes, then it is proceeded with step 870. In step 870, it is determined that there are defect memory blocks in the CXL device, and the firmware/OS (of the second host) maps out the invalid memory units according to the CDAT.

Further details and aspects are mentioned in connection with the examples described above. The example shown in FIG. 8 may include one or more optional additional features corresponding to one or more aspects mentioned in connection with the proposed concept or one or more examples described above (e.g., FIGS. 1 to 7).

In the following, some examples of the proposed concept are presented:

An example (e.g., example 1) relates to a method comprising obtaining information about a detected memory error in a memory device, the memory device being connected to a first host via a compute express link, CXL, interface, and recording the memory error information into a firmware of the memory device.

Another example (e.g., example 2) relates to a previous example (e.g., example 1) or to any other example, further comprising that the memory error information is recorded into a device attribute table, DAT, of the firmware of the memory device.

Another example (e.g., example 3) relates to a previous example (e.g., one of the examples 1 to 2) or to any other example, further comprising communicating between the first host and the memory device based on a data object exchange, DOE, interface.

Another example (e.g., example 4) relates to a previous example (e.g., one of the examples 1 to 3) or to any other example, further comprising communicating the error memory error information between the first host and the memory device based on a first data structure.

Another example (e.g., example 5) relates to a previous example (e.g., example 4) or to any other example, further comprising that the first data structure comprises a write entry request field.

Another example (e.g., example 6) relates to a previous example (e.g., one of the examples 4 to 5) or to any other example, further comprising that the first data structure is a CXL data object exchange, DOE, access table.

Another example (e.g., example 7) relates to a previous example (e.g., one of the examples 1 to 6) or to any other example, further comprising that the firmware comprises a second data structure, the second data structure comprising data specifying the detected memory error of the memory device.

Another example (e.g., example 8) relates to a previous example (e.g., example 7) or to any other example, further comprising that the second data structure is included in a coherent device attribute table, CDAT, of the firmware of the memory device.

Another example (e.g., example 9) relates to a previous example (e.g., one of the examples 7 to 8) or to any other example, further comprising that the second data structure specifies at least one of a physical memory address of the memory device associated with the memory error, a range of a physical memory address of the memory device associated with the memory error, a device physical address base or a device physical address size.

Another example (e.g., example 10) relates to a previous example (e.g., one of the examples 7 to 9) or to any other example, further comprising that the second data structure is a device scoped memory defect structure, DSMDS.

Another example (e.g., example 11) relates to a previous example (e.g., one of the examples 1 to 10) or to any other example, further comprising that recording the memory error information into the firmware of the memory device is triggered by a memory reliability management module.

Another example (e.g., example 12) relates to a previous example (e.g., example 11) or to any other example, further comprising that the memory reliability management module is a reliability, availability, and serviceability, RAS, feature, and/or the firmware of the first host is a basic input/output system, BIOS.

Another example (e.g., example 13) relates to a previous example (e.g., one of the examples 1 to 12) or to any other example, further comprising receiving a write entry response after recording the memory error information about the detected memory error into the firmware of the memory device.

Another example (e.g., example 14) relates to a previous example (e.g., one of the examples 1 to 13) or to any other example, further comprising switching the memory device from being connected to the first host to being connected to a second host via the CXL interface, and obtaining by the second host the recorded memory error information about the detected memory error from the firmware of the memory device.

Another example (e.g., example 15) relates to a previous example (e.g., example 14) or to any other example, further comprising that the recorded memory error information is obtained from a from the firmware of the memory device.

An example (e.g., example 16) relates to an apparatus comprising interface circuitry, machine-readable instructions and processing circuitry to execute the machine-readable instructions to obtain information about a detected memory error in a memory device, the memory device being connected to a first host via a compute express link, CXL, interface, and record the memory error information into a firmware of the memory device.

Another example (e.g., example 17) relates to a previous example (e.g., example 16) or to any other example, further comprising that the memory error information is recorded into a device attribute table, DAT, of the firmware of the memory device.

Another example (e.g., example 18) relates to a previous example (e.g., one of the examples 16 or 17) or to any other example, further comprising that the processing circuitry is further to execute the machine-readable instructions to communicate between the first host and the memory device based on a data object exchange, DOE, interface.

Another example (e.g., example 19) relates to a previous example (e.g., one of the examples 16 to 18) or to any other example, further comprising that the processing circuitry is further to execute the machine-readable instructions to communicate the error memory error information between the first host and the memory device based on a first data structure.

Another example (e.g., example 20) relates to a previous example (e.g., example 19) or to any other example, further comprising that the first data structure comprises a write entry request field.

Another example (e.g., example 21) relates to a previous example (e.g., one of the examples 19 to 20) or to any other example, further comprising that the first data structure is a CXL data object exchange, DOE, access table.

Another example (e.g., example 22) relates to a previous example (e.g., one of the examples 16 to 21) or to any other example, further comprising that the firmware comprises a second data structure, the second data structure comprising data specifying the detected memory error of the memory device.

Another example (e.g., example 23) relates to a previous example (e.g., example 22) or to any other example, further comprising that the second data structure is included in a coherent device attribute table, CDAT, of the firmware of the memory device.

Another example (e.g., example 24) relates to a previous example (e.g., one of the examples 22 to 23) or to any other example, further comprising that the second data structure specifies at least one of a physical memory address of the memory device associated with the memory error, a range of a physical memory address of the memory device associated with the memory error, a device physical address base or a device physical address size.

Another example (e.g., example 25) relates to a previous example (e.g., one of the examples 22 to 24) or to any other example, further comprising that the second data structure is a device scoped memory defect structure, DSMDS.

Another example (e.g., example 26) relates to a previous example (e.g., one of the examples 16 to 25) or to any other example, further comprising that recording the memory error information into the firmware of the memory device is triggered by a memory reliability management module.

Another example (e.g., example 27) relates to a previous example (e.g., example 26) or to any other example, further comprising that the memory reliability management module is a reliability, availability, and serviceability, RAS, feature, and/or the firmware of the first host is a basic input/output system, BIOS.

Another example (e.g., example 28) relates to a previous example (e.g., one of the examples 16 to 27) or to any other example, further comprising that the processing circuitry is further to execute the machine-readable instructions to receive a write entry response after recording the memory error information about the detected memory error into the firmware of the memory device.

Another example (e.g., example 29) relates to a previous example (e.g., one of the examples 16 to 28) or to any other example, further comprising that the processing circuitry is further to execute the machine-readable instructions to switch the memory device from being connected to the first host to being connected to a second host via the CXL interface, and obtain by the second host the recorded memory error information about the detected memory error from the firmware of the memory device.

Another example (e.g., example 30) relates to a previous example (e.g., example 29) or to any other example, further comprising that the recorded memory error information is obtained from a from the firmware of the memory device.

An example (e.g., example 31) relates to an apparatus comprising interface circuitry, machine-readable instructions and processing circuitry to execute the machine-readable instructions to obtain a recorded memory error information about a detected memory error from a firmware of a memory device connected to a second host, wherein the memory error was detected while the memory device was connected to a first host, and wherein the corresponding memory error information was recorded into the firmware of the memory device while the memory device was connected to the first host.

Another example (e.g., example 32) relates to a System comprising the apparatus of any one of examples 16 to 30 and the apparatus of example 31.

An example (e.g., example 33) relates to a non-transitory machine-readable storage medium including firmware for an apparatus, when executed causing the apparatus to detect a memory error in a memory device, the memory device being connected to a first host via a compute express link, CXL, interface, and record the memory error information about the detected memory error into a firmware of the memory device.

An example (e.g., example 34) relates to a non-transitory machine-readable storage medium including firmware for a CXL memory device, when executed causing an apparatus to obtain a recorded memory error information about a detected memory error from the CXL memory device connected to a second host, wherein the memory error was detected while the memory device was connected to a first host, and wherein the corresponding memory error information was recorded into the firmware of the memory device while the memory device was connected to the first host.

An example (e.g., example 34) relates to an apparatus comprising processor circuitry configured to obtain information about a detected memory error in a memory device, the memory device being connected to a first host via a compute express link, CXL, interface, and record the memory error information into a firmware of the memory device.

An example (e.g., example 35) relates to an apparatus comprising processor circuitry configured to obtain a recorded memory error information about a detected memory error from a firmware of a memory device connected to a second host, wherein the memory error was detected while the memory device was connected to a first host, and wherein the corresponding memory error information was recorded into the firmware of the memory device while the memory device was connected to the first host.

An example (e.g., example 36) relates to a device comprising means for processing for obtaining information about a detected memory error in a memory device, the memory device being connected to a first host via a compute express link, CXL, interface, and recording the memory error information into a firmware of the memory device.

An example (e.g., example 37) relates to a device comprising means for processing for obtaining a recorded memory error information about a detected memory error from a firmware of a memory device connected to a second host, wherein the memory error was detected while the memory device was connected to a first host, and wherein the corresponding memory error information was recorded into the firmware of the memory device while the memory device was connected to the first host.

Another example (e.g., example 38) relates to a non-transitory machine-readable storage medium including program code, when executed, to cause a machine to perform the method of any one of examples 1 to 15.

Another example (e.g., example 39) relates to a computer program having a program code for performing the method of any one of examples 1 to 15 when the computer program is executed on a computer, a processor, or a programmable hardware component.

Another example (e.g., example 40) relates to a machine-readable storage including machine readable instructions, when executed, to implement a method or realize an apparatus as claimed in any pending examples.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method comprising:
obtaining information about a detected memory error in a memory device, the memory device being connected to a first host via a compute express link, CXL, interface; and
recording the memory error information into a firmware of the memory device.

2. The method of according to claim 1, wherein the memory error information is recorded into a device attribute table, DAT, of the firmware of the memory device.

3. The method according to claim 1, further comprising communicating between the first host and the memory device based on a data object exchange, DOE, interface.

4. The method according to claim 1, further comprising communicating the error memory error information between the first host and the memory device based on a first data structure.

5. The method according to claim 4, wherein the first data structure comprises a write entry request field.

6. The method according to claim 4, wherein the first data structure is a CXL data object exchange, DOE, access table.

7. The method according to claim 1, wherein the firmware comprises a second data structure, the second data structure comprising data specifying the detected memory error of the memory device.

8. The method according to claim 7, wherein the second data structure is included in a coherent device attribute table, CDAT, of the firmware of the memory device.

9. The method according to claim 7, wherein the second data structure specifies at least one of a physical memory address of the memory device associated with the memory error, a range of a physical memory address of the memory device associated with the memory error, a device physical address base or a device physical address size.

10. The method according to claim 7, wherein the second data structure is a device scoped memory defect structure, DSMDS.

11. The method according to claim 1, wherein recording the memory error information into the firmware of the memory device is triggered by a memory reliability management module.

12. The method according to claim 11, wherein the memory reliability management module is a reliability, availability, and serviceability, RAS, feature, and/or the firmware of the first host is a basic input/output system, BIOS.

13. The method according to claim 1, further comprising receiving a write entry response after recording the memory error information about the detected memory error into the firmware of the memory device.

14. The method according to claim 1, further comprising:
switching the memory device from being connected to the first host to being connected to a second host via the CXL interface; and
obtaining by the second host the recorded memory error information about the detected memory error from the firmware of the memory device.

15. The method according to claim 14, wherein the recorded memory error information is obtained from a from the firmware of the memory device.

16. An apparatus comprising interface circuitry, machine-readable instructions and processing circuitry to execute the machine-readable instructions to:
obtain information about a detected memory error in a memory device, the memory device being connected to a first host via a compute express link, CXL, interface; and
record the memory error information into a firmware of the memory device.

17. The apparatus of claim 16, wherein the memory error information is recorded into a device attribute table, DAT, of the firmware of the memory device.

18. The apparatus of claim 16, wherein the processing circuitry is further to execute the machine-readable instructions to communicate between the first host and the memory device based on a data object exchange, DOE, interface.

19. The apparatus of claim 16, wherein the processing circuitry is further to execute the machine-readable instructions to communicate the error memory error information between the first host and the memory device based on a first data structure.

20. A non-transitory machine-readable storage medium including firmware for a CXL memory device, when executed causing an apparatus to obtain a recorded memory error information about a detected memory error from the CXL memory device connected to a second host, wherein the memory error was detected while the memory device was connected to a first host, and wherein the corresponding memory error information was recorded into the firmware of the memory device while the memory device was connected to the first host.
